(19) United States
(12) Patent Application Publication
(10) Pub. No.: US 2022/0218098 A1
(43) Pub. Date: Jul. 14, 2022

(54) Polyester-Based Monofilament for Toothbrush

(71) Applicant: Asahi Kasei Advance Corporation, Tokyo (JP)

(72) Inventors: Shigeru Morita, Tokyo (JP); Akihiro Saito, Tokyo (JP); Haruka Sakamoto, Tokyo (JP)

(73) Assignee: Asahi Kasei Advance Corporation, Tokyo (JP)

(21) Appl. No.: 17/632,401

(22) PCT Filed: Aug. 21, 2019
(86) PCT No.: PCT/JP2019/032664

§ 371 Date: Feb. 2, 2022

(51) Int. Cl. A46D 1/00; D01F 6/92; A46B 9/04; D01D 5/12; D01D 5/08

(52) U.S. Cl. CPC A46D 1/0269; A46D 1/0207; D01F 6/92; A46B 2200/1066; D01D 5/12; D01D 5/082; A46B 9/04

(57) ABSTRACT

Provided is a polyester-based monofilament for a toothbrush, the monofilament having exceptional flexibility (usage feel), durability (bristle breaking resistance), and restoration properties (bristle opening resistance). The present invention relates to: a polyester-based monofilament for a toothbrush, the monofilament being characterized in that polytrimethylene terephthalate (PTT) and polybutylene terephthalate (PBT) are mixed at a proportion ranging from 85/15 to 65/35 in terms of weight ratio, and the shrinkage in boiling water is less than 1.0%; and a toothbrush in which the aforementioned polyester-based monofilament for a toothbrush is used in an erected bristle section.

### FIELD

The present invention relates to a polyester-based monofilament for a toothbrush. More specifically, the invention relates to a polyester-based monofilament for a toothbrush having exceptional flexibility (usage feel), durability (bristle-breaking resistance) and recoverability (bristle-opening resistance), as well as to a method for producing it.

### BACKGROUND

Monofilaments comprising polytrimethylene terephthalate (hereunder, “PTT”), and toothbrushes using them as erected bristles, have become a subject of interest in recent years for their excellent recoverability.

PTL 1 discloses a toothbrush using PTT, which it describes as having excellent recoverability.

PTL 2 discloses different brushes using PTT as the bristle material, being described as high-performance brushes when they are used as toothbrushes, and having excellent erected strength and elastic recovery of the bristle materials, with low changes over time due to their low moisture absorption.

PTL 3 discloses a monofilament comprising PTT which is described as a brush having excellent bending recoverability and durability with prolonged use. Specifically, PTL 3 states that for the monofilament comprising PTT, the boiling water shrinkage ratio is reduced to 2% or lower by heat treatment with a relaxation ratio in the range of −10 to +15%, and that it is not desirable for the relaxation ratio to exceed +15% so that the monofilament is in a relaxed state even after heat treatment.

PTL 3 also states that by conducting relaxation heat treatment under specified conditions in production of the PTT monofilament to lower the boiling water shrinkage ratio to 2% or lower, the molecular structure of the PTT is stabilized and a brush is obtained having excellent bristle-breaking durability with prolonged use.

In PTL 4 there is described a monofilament comprising a mixture of 5 to 45 wt % PTT and 95 to 55 wt % of a polyester-based resin other than PTT, as a brush material with low change in elasticity upon water absorption, and improved durability.

However, the toothbrushes comprising PTT monofilaments disclosed in PTLs 1 to 4, while having excellent elastic recovery and bending durability, are problematic in that they have high stiffness and lack flexibility when used as toothbrushes, and thus cause irritation to the gums of children, for example.

PTL 5 proposes a toothbrush monofilament with excellent transparency and flexibility and superior cleanability and usage durability, comprising PTT and a copolymerized polyester A combined in a weight ratio of 90/10 to 45/55, wherein the copolymerized polyester A has a specific melting point, the polymer blend has a specific crystallization peak temperature and melting point, and inorganic microparticles are included at a specific content. An isophthalic acid-copolymerized PET resin is mentioned specifically for use as the copolymerized polyester A. For production of the monofilament, the monofilament is first wound and heated for 72 hours at 80° C. in a non-constrained state to obtain the final monofilament. However, the boiling water shrinkage ratio of the monofilament obtained in PTL 5 is 2.5 to 3.7%, and PTL 5 states that with a boiling water shrinkage ratio of less than 1%, the monofilament is in an excessively heat set state, causing it to be prone to breakage during spinning.

PTL 6 proposes a toothbrush monofilament with excellent transparency and flexibility and superior durability, comprising PTT and polybutylene terephthalate (PBT) blended in a weight ratio of 70/30 to 45/55, which has a boiling water shrinkage ratio of 1 to 5%, and a specific crystallization peak temperature and melting peak temperature, with inorganic microparticles being included at a specific content. For production of the monofilament, the monofilament is first wound and heated for 72 hours at 80° C. in a non-constrained state to obtain the final monofilament. However, the heat treatment in a non-constrained state in PTL 6 differs from the “heat treatment even while maintaining a relaxed state until heat treatment is complete” according to the present invention, and therefore, similar to PTL 5, the boiling water shrinkage ratio of the monofilament obtained in PTL 6 exceeds 1.0%, and with a boiling water shrinkage ratio of less than 1% the monofilament is brought to an excessively heat-set state, causing it to be prone to breakage during spinning. PTL 6 also states that a PTT mixing ratio of greater than 70% lowers the effect of increased durability and flexibility provided by PBT.

### CITATION LIST

### Patent Literature

[PTL 1] International Patent Publication No. WO99/05936

### [PTL 2] Japanese Unexamined Patent Publication HEI No. 08-173244

[PTL 3] International Patent Publication No. WO01/75200

### [PTL 4] Japanese Unexamined Patent Publication No. 2004-141504

### [PTL 5] Japanese Unexamined Patent Publication No. 2006-37273

### [PTL 6] Japanese Unexamined Patent Publication No. 2006-2256

### SUMMARY

### Technical Problem

In light of the prior art described above, the problem to be solved by the invention is to provide a polyester-based monofilament for a toothbrush with excellent flexibility (usage feel), durability (bristle-breaking resistance) and recoverability (bristle-opening resistance), compared to a conventional polyester-based monofilament for a toothbrush.

### Solution to Problem

The present inventors have conducted much diligent research with the goal of solving this problem, and as a result have completed this invention upon finding, unexpectedly, that by optimizing the blending ratio of PPT and PBT and also by winding the melt-spun, stretched and heat-treated monofilament before conducting relaxation heat treatment at 70° C. to 110° C. for 36 hours or longer in a non-constrained state, it is possible to obtain a polyester-based monofilament for a toothbrush having a lowered boiling water shrinkage ratio of the resulting monofilament, and excellent flexibility (usage feel), durability (bristle-breaking resistance) and recoverability (bristle-opening resistance).

Specifically, the present invention provides the following.

[1] A polyester-based monofilament for a toothbrush comprising polytrimethylene terephthalate (PTT) and polybutylene terephthalate (PBT) blended in a weight ratio of 85/15 to 65/35, and having a boiling water shrinkage ratio of less than 1.0%.

[2] The polyester-based monofilament for a toothbrush according to [1] above, wherein the toughness (=breaking strength (cN/dtex)×√breaking elongation (%)) of the monofilament is 18 or greater, and the breaking elongation is 55% or greater.

[3] The polyester-based monofilament for a toothbrush according to [1] or [2] above, wherein the fiber diameter of the monofilament is 150 μm to 200 μm.

[4] A toothbrush that employs a polyester-based monofilament for a toothbrush according to any one of [1] to [3] above as the erected bristles.

[5] A method for producing a polyester-based monofilament for a toothbrush according to any one of [1] to [3] above, wherein the method comprises the following steps:

a step of blending polytrimethylene terephthalate (PTT) and polybutylene terephthalate (PBT) in a weight ratio of 85/15 to 65/35, and then melt spinning the blend;

a step of stretching the melt spun monofilament, and then heat treating it and temporarily winding it; and

a step of heat treating the wound monofilament at a heat treatment temperature of 70° C. to 110° C. for a heat treatment time of 36 hours or longer in a non-constrained state, while maintaining a relaxed state until heat treatment is complete.

### Advantageous Effects of Invention

The polyester-based monofilament for a toothbrush of the invention has excellent flexibility (usage feel), durability (bristle-breaking resistance) and recoverability (bristle-opening resistance), compared to a conventional polyester-based monofilament for a toothbrush.

### BRIEF DESCRIPTION OF DRAWINGS

FIG. 1 is a schematic diagram showing an example of a monofilament melt spinning stretching machine according to an embodiment of the invention.

### DESCRIPTION OF EMBODIMENTS

An embodiment of the invention will now be described in detail.

The polyester-based monofilament for a toothbrush of this embodiment comprises polytrimethylene terephthalate (PTT) and polybutylene terephthalate (PBT) blended in a weight ratio of 85/15 to 65/35, and having a boiling water shrinkage ratio of less than 1.0%.

For this embodiment, the polytrimethylene terephthalate (PTT) and polybutylene terephthalate (PBT) are present as repeating units with the trimethylene terephthalate at 90 mol % or greater and the butylene terephthalate at 90 mol % or greater. If the repeating units are less than 90 mol %, the melting points of PTT and PBT will each be low at 200° C. or lower, which is unsuitable for use as a material.

For this embodiment, the PTT and PBT may be homo- or copolymerized polytrimethylene terephthalate and homo- or copolymerized polybutylene terephthalate, respectively, containing another ester repeating unit at 10 mol % or lower. Representative examples of copolymerizing components include acid components, among which are aromatic dicarboxylic acids such as isophthalic acid or 5-sodiumsulfoisophthalic acid, and aliphatic dicarboxylic acids such as adipic acid or itaconic acid. Glycol components include ethylene glycol, butylene glycol and polyethylene glycol. A hydroxycarboxylic acid such as hydroxybenzoic acid may also be used. Multiple acid components and glycol components may also be copolymerized.

One feature of this embodiment is that PTT and PBT, as the two types of polyesters to be blended, are selected in a specified proportion for a weight ratio of 85/15 to 65/35. With this specific mixing ratio, it is possible to satisfy the desired flexibility (usage feel), durability (bristle-breaking resistance) and recoverability (bristle-opening resistance) of the obtained monofilament.

The reason for this will now be explained.

First, since both of the two different polyesters, PTT and PBT, are polyester resins, the hygroscopicity is low, so that changes in physical properties and functional changes caused by environmental changes in humidity are minimal. PTT characteristically has excellent stretch recoverability because of the flat zigzag structure of the molecular chains. This characteristic produces an effect of inhibiting the phenomenon in which the bristle material undergoes plastic deformation, i.e. “bristle opening”, when used as a toothbrush bristle material. PBT, on the other hand, is a polymer with comparatively excellent stretch recoverability, though not as high as that of PTT, and therefore the stretch recoverability is not reduced very much even when PBT is blended with PTT. Moreover, since both PBT and PTT are aromatic polyesters with relatively similar structures, they are suitably compatible and are unlikely to separate from their polymer boundaries when blended. Since the melting points of PTT or PBT are close at approximately 230° C., they readily form a polymer blend when melted.

In the monofilament of this embodiment, it is conjectured that PTT and PBT are compatible in the amorphous phase, while PTT and PBT each exist independently in the crystal phase. Compatibility in the amorphous phase increases the transparency of the monofilament, while their independent presence in the crystal phase provides the property of stretch recovery as one of the features of PTT.

When two different polyesters are mixed in a molten state, they generally undergo transesterification reaction and copolymerization. With a greater amount of copolymer produced, compatibility between the PTT and PBT increases due to compatibilizing role of the copolymer, tending to lower the crystallinity of the PTT and PBT.

The reason for the improved durability (bristle-breaking resistance) is conjectured to be as follows.

Since the glass transition temperature of PBT is about 25° C. and the glass transition temperature of PTT is lower than about 50° C., PTT is in a glassy state and PBT is in a rubbery state in the amorphous phase of the mixture of PTT and PBT, when in the range of 25 to 50° C. as the ordinary operating temperature range. Because intraoral temperature is about 36° C. which is within this temperature range, when a mixture of PTT and PBT is used as a toothbrush bristle material and the toothbrush is used for long periods, defects formed in the toothbrush surface tend to grow into cracks and further cause bristle breakage, but this phenomenon is prevented by PBT in a rubbery state. Mixtures of PTT and PBT, therefore, have superior durability (bristle-breaking resistance) compared to monofilaments composed of 100% PTT.

The reason for the improved recoverability (bristle-opening resistance) is conjectured to be as follows.

Since the elastic modulus of the amorphous portion is lowered when PBT transitions to the rubbery state, this increases the flexibility of the monofilament. Therefore if the blending ratio of PBT is too high, it will reduce the effect of the PTT bristle material which inhibits the phenomenon of plastic deformation or “bristle opening”, thus impairing the recoverability (bristle-opening resistance).

In the monofilament of the embodiment, the mixing ratio of PTT and PBT must be a weight ratio of 85/15 to 65/35. If the mixing ratio of PTT is less than 65 wt %, the PTT crystal phase will be reduced, resulting in insufficient stretch recoverability of the monofilament. If the mixing ratio of PTT is greater than 85%, on the other hand, the effect of improving flexibility and the effect of improving recoverability (bristle-opening resistance) due to PBT, as described below, will be reduced. The preferred mixing ratio for PTT and PBT may be 80/20 to 70/30, in terms of weight ratio.

Another feature of this embodiment is that the boiling water shrinkage ratio of the monofilament after heat setting is less than 1.0%. If the boiling water shrinkage ratio is within this specified range, with the weight ratio of PTT and PBT selected in the specified proportion of 85/15 to 65/35, the flexibility (usage feel), durability (bristle-breaking resistance) and recoverability (bristle-opening resistance) of the obtained monofilament can be satisfied. The lower limit is not particularly restricted but is preferably 0.1% or greater, and more preferably 0.25% or greater.

The reason for this will now be explained.

A low boiling water shrinkage ratio for synthetic fiber yarn is generally understood to mean that the yarn has undergone excessive heat setting and crystallization, and has excellent recoverability in response to bending changes, i.e. excellent linearity, and reduced flexibility. If the boiling water shrinkage ratio is high, conversely, this increases the flexibility, and reduces the effect of the PTT bristle material which inhibits the phenomenon of plastic deformation or “bristle opening”, thus impairing the recoverability (bristle-opening resistance).

As mentioned above, PTL 3 states that for the monofilament comprising PTT, the boiling water shrinkage ratio is reduced to 2% or lower by heat treatment under specified conditions, specifically with a relaxation ratio in the range of −10 to +15%, and also that it is not desirable for the relaxation ratio to exceed +15% so that the monofilament is in a relaxed state even after heat treatment. It is conjectured, therefore, that within the range for the relaxation ratio described in PTL 3, shrinkage of the yarn proceeds during heat treatment even if it is in a non-constrained state during the initial stage of the heat treatment, and therefore the heat treatment actually takes place in a constrained state. Under the aforementioned specified conditions, however, even though the boiling water shrinkage ratio of a monofilament of PTT alone may be less than 1%, it is difficult to lower the boiling water shrinkage ratio of a monofilament comprising a blend of PTT and PBT in the specified proportion to less than 1%.

As mentioned above, PTL 6 describes a toothbrush monofilament having PTT and PBT blended in a weight ratio of 70/30 to 45/55, and having a boiling water shrinkage ratio of 1 to 5%. In production of the monofilament in PTL 6, the wound monofilament is heated for 72 hours at 80° C. in a non-constrained state to obtain a monofilament (i.e. heat treatment is carried out in a wound body state), but the boiling water shrinkage ratio of the obtained monofilament exceeds 1.0%. It is mentioned that the state where the boiling water shrinkage ratio is less than 1% is a state in which the monofilament is subjected to excessive heat setting, and that this state tends to result yarn breakage during spinning.

The present inventors have found that, contradictory to the teachings of PTLs 3 and 6, heat treatment while maintaining a relaxed state until heat treatment is complete allows the boiling water shrinkage ratio of the monofilament after heat setting to be in a specified range, and specifically less than 1.0%, and that by limiting the weight ratio of PTT and PBT to a specific blending ratio of 85/15 to 65/35, the flexibility (usage feel), durability (bristle-breaking resistance) and recoverability (bristle-opening resistance) of the monofilament are all satisfied.

In PTL 6, as mentioned above, the wound monofilament is subjected to heat setting conditions in which it is heated for 72 hours at 80° C. in a non-constrained state, to obtain a monofilament, but for this embodiment as explained below, the wound monofilament is subjected to a heat treatment step in a non-constrained state, as a wound skein, for example, with a heat treatment temperature of 70° C. to 110° C. and a heat treatment time of 36 hours or longer and maintaining a relaxed state until heat treatment is complete (this will be referred to hereunder simply as “relaxation heat treatment”), to obtain a monofilament having a boiling water shrinkage ratio in the specified range of less than 1.0%. That is, for this embodiment relaxation heat treatment is carried out with a wound skein in a non-constrained state, to obtain a boiling water shrinkage ratio that is lower than the boiling water shrinkage ratio range of 1 to 5% as taught in PTL 6. For this embodiment, by limiting the boiling water shrinkage ratio to a range lower than the prior art for a toothbrush monofilament made of PTT and PBT in the specified blending ratio, a toothbrush monofilament is provided which can satisfy all of the properties of flexibility (usage feel), durability (bristle-breaking resistance) and recoverability (bristle-opening resistance). The boiling water shrinkage ratio of the polyester-based monofilament for a toothbrush of this embodiment is preferably 0.45% to 0.95% and more preferably 0.50 to 0.90%.

For this embodiment, a step of relaxation heat treatment is carried out as a wound skein in a non-constrained state, for example, at a heat treatment temperature of 70° C. to 110° C. and a heat treatment time of 36 hours or longer, maintaining a relaxed state until heat treatment is complete. Since the monofilament is not in an excessively heat-set state in this heating step, yarn breakage does not occur, and yet since heat setting of the monofilament is not insufficient, reeling defects are not produced upon tightening when the monofilament is stored for long periods.

One example of a method of heat treatment with a specific relaxation ratio is a method in which the monofilament in a wound skein state is placed between two rods set in a heating room, and heat treated. In contrast, heat treatment for production of the polyester-based monofilament for a toothbrush of this embodiment may be a method of heat treatment after placing the monofilament in a heating room in the form of a wound skein without constraint, for example, whereby a relaxed state can be maintained until the heat treatment is complete. Although a method of heat treating monofilaments after cutting to the same specified length (such as the length of toothbrush bristles) and bundling them is also possible, this is undesirable because variation may occur in the yarn lengths within the bundle if the heated state is non-homogeneous, and this is unsuitable as a product.

Preferably, the toughness (=breaking strength (cN/dtex)×√breaking elongation (%)) of the monofilament of this embodiment is 18 or greater, and the breaking elongation is 55% or greater.

The breaking elongation of the monofilament is preferably 55 to 70%. With a breaking elongation within this range, the monofilament yarn will exhibit toughness without splintering of the toothbrush bristles even with prolonged use, and thickness of the monofilament in the yarn length direction will also be uniform without variation, resulting in high commercial value.

The breaking strength of the monofilament is preferably 2.2 cN/dtex or greater. If the breaking strength is within this range, the strength will be adequate and splintering or attrition of the toothbrush bristles will not occur even with prolonged use.

The toughness (=breaking strength (cN/dtex)×√breaking elongation (%)) of the monofilament of this embodiment may be 16.3 or greater, but it is preferably 18 or greater.

The fiber diameter of the monofilament of this embodiment is preferably 150 μm to 200 μm. If the fiber diameter of the monofilament is 150 μm to 200 μm, the strength and bending recoverability will both be adequate, allowing it to satisfy the performance required for a toothbrush.

The size of the monofilament of this embodiment may be set as desired according to the type of toothbrush, but it is preferably 200 to 400 dtex from the viewpoint of excellent flexibility, transparency and durability of the monofilament, and of obtaining a toothbrush with an excellent effect of removing dental plaque during use.

The cross-sectional shape of the monofilament of this embodiment is also not particularly restricted, and it may be round, triangular or quadrilateral, or irregular such as H- or W-shaped, or may have a hollow cross-sectional shape.

The method of producing the monofilament of this embodiment will now be described in detail.

The method for producing the monofilament of this embodiment comprises the following steps:

a step of blending polytrimethylene terephthalate (PTT) and polybutylene terephthalate (PBT) in a weight ratio of 85/15 to 65/35, and then melt spinning the blend;

a step of stretching the melt spun monofilament, and then heat treating it and temporarily winding it; and

a step of heat treating the wound monofilament at a heat treatment temperature of 70° C. to 110° C. for a heat treatment time of 36 hours or longer in a non-constrained state, as in the state of a wound skein, for example, while maintaining a relaxed state until heat treatment is complete.

The method of producing the PTT and PBT polymers for this embodiment may be any publicly known method, and they will typically be high viscosity PTT and PBT resins obtained by a two-stage polymerization method in which the polymerization degree is raised by melt polymerization to a constant intrinsic viscosity, and then increased to a polymerization degree corresponding to a predetermined intrinsic viscosity by solid-phase polymerization.

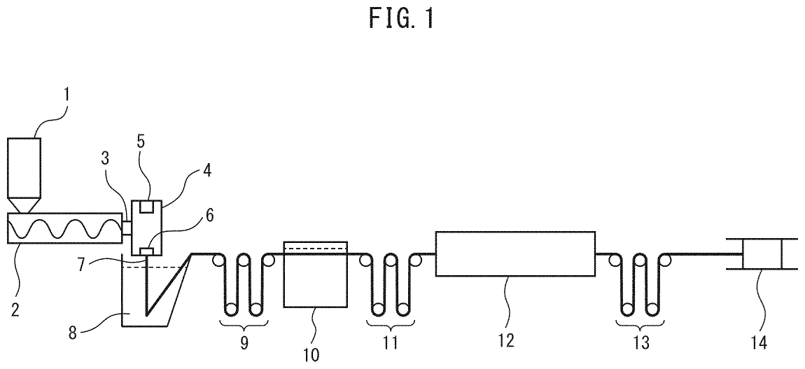

The polyester-based monofilament of this embodiment can be obtained by melt spinning a PTT/PBT mixed resin using a known water-cooling spinning machine such as shown in FIG. 1 and a stretching-heat setting machine connected to it, cooling the blend, and then stretching and further heat treating it. The spinning conditions, stretching temperature, stretch ratio, heat treatment temperature and take-up speed during this process may be adjusted to obtain a polyester-based monofilament having the desired physical properties. The heat treatment may be carried out on a separate line after stretching, or stretching may follow spinning in a continuous manner. For this embodiment, however, the wound monofilament, i.e. the monofilament that has left the winder shown in FIG. 1, is subjected to a step of relaxation heat treatment at a heat treatment temperature of 70° C. to 110° C. and a heat treatment time of 36 hours or longer, while maintaining a relaxed state until heat treatment is complete, by being in a non-constrained state such as in the state of a wound skein, to keep the boiling water shrinkage ratio within the predetermined range. The heat treatment temperature is preferably 90° C. or lower and the heat treatment time is preferably 72 hours or less and more preferably 48 to 72 hours.

The PTT/PBT resin mixture that has been blended beforehand in a weight ratio of 85/15 to 65/35 is dried in a dryer 1, and the mixture is then supplied to an extruder 2 to obtain a melt of the resin mixture. The molten resin mixture is then sent to a spin head 4 through a bend 3, measured with a gear pump 5 mounted along the way, and spun out through a spinneret 6.

The spun resin mixture becomes a filamentous polymer 7 which is fed into a cooling bath 8 and cooled while being pulled by a first roll group 9 rotating at a constant rate, thus being thinned to a predetermined size to produce an unstretched monofilament. The temperature of the cooling bath is 20 to 60° C. and preferably 30 to 50° C. After the unstretched monofilament has passed through the first roll group 9, it is pulled by a second roll group 11 rotating at a constant rate in a stretching bath 10 at a predetermined temperature as first-stage stretching. The temperature of the stretching bath is preferably 40 to 90° C. and more preferably 50 to 70° C. The monofilament is then subjected to heat setting treatment in a heat treatment bath 12 at a predetermined temperature and passed through a third roll group 13, and then wound up on a winder 14. The temperature of the heat treatment bath is preferably 120 to 180° C. and more preferably 140 to 180° C.

During production of the polyester-based monofilament of this embodiment, the stretching step may be a single stage of stretching, but preferably the stretching step is divided into multiple stages with two or more stages of stretching. Before the step of heat treatment at a heat treatment temperature of 70° C. to 110° C. and a heat treatment time of 36 hours or longer, while maintaining a relaxed state until heat treatment is complete in the non-constrained skein state described above, the obtained monofilament may be subjected to heat treatment with a predetermined temperature and time and in a predetermined state of relaxation, to adjust the boiling water shrinkage ratio of the monofilament to a desired value. The heating medium used in the heat treatment bath 13 is selected from among hot air, steam, silicon oil and alkylene glycols. The heat treatment time is preferably a long time within a range that does not interfere with productivity, and for most cases will be preferably 1 to 100 seconds.

The polyester-based monofilament of this embodiment may also contain added inorganic fine particles to increase the smoothness of the monofilament and improve the melt spinnability, or a finishing agent with the function of lowering the friction resistance or imparting an antistatic property in order to improve the processability in post-processing steps, or it may further contain a water-repellent agent or water absorbent depending on a required function. A finishing agent is preferably added after the third roll group 13.

In the method of producing a monofilament of this embodiment, the melting temperature is preferably 250 to 270° C. and more preferably 255 to 265° C. If the melting temperature is lower than 250° C., melting of the PTT and/or PBT will be incomplete, making it impossible to accomplish stable industrial production of a monofilament. If the melting temperature is higher than 270° C., on the other hand, thermal decomposition and molecular weight reduction of the PTT and/or PBT will proceed, lowering the recoverability and durability of the monofilament.

In the method of producing the monofilament of this embodiment, the residence time of the resin mixture as a melt from the time it is loaded into the extruder until it is spun is preferably 2 to 20 minutes. When the PTT and PBT are mixed in a molten state, transesterification reaction takes place, resulting in their copolymerization. With a greater amount of copolymer produced, compatibility between the PTT and PBT increases due to the compatibilizing role of the copolymer, and this tends to lower the crystallinity of the PTT and PBT. If the residence time exceeds 20 minutes, copolymerization proceeds resulting in lower crystallinity of the PTT and reduced recoverability of the monofilament. If the residence time is less than 2 minutes, on the other hand, melting of the PTT and/or PBT will be incomplete, making it impossible to accomplish stable industrial production of a monofilament.

In the method of producing the monofilament of this embodiment, the screw shear rate is preferably 5 to 300 (per second). The screw shear rate is calculated by the following formula:

Screw shear rate=πDN/60/H

{where π: circular constant, D: screw diameter (mm), N: screw rotational speed (rpm), H: groove depth of screw weighing part (mm)}.

If the screw shear rate is less than 5 (per second), then it will not be possible for the resin mixture of PTT and PBT to be stably introduced into the extruder. If the screw shear rate is greater than 300 (per second), on the other hand, the shearing heat release of the resin mixture will increase, causing thermal decomposition and molecular weight reduction of the PTT and/or and PBT to proceed, lowering the recoverability and durability of the monofilament.

### EXAMPLES

The present invention will now be explained in detail using Examples and Comparative Examples.

The measuring methods and measuring conditions for the physical properties used in the Examples and Comparative Examples will be explained first.

### (1) Strength (Tensile Strength) (N)

This was measured according to JIS-L-1013. The average value for 10 measurements was calculated.

(2) Breaking Strength (cN/dtex)

This was measured according to JIS-L-1013. The average value for 10 measurements was calculated.

### (3) Breaking Elongation (%)

This was measured according to JIS-L-1013. The average value for 10 measurements was calculated.

### (4) Toughness

This was determined by the following formula:

Toughness=breaking strength (cN/dtex)×√breaking elongation (%).

### (5) Boiling Water Shrinkage Ratio (%)

The boiling water shrinkage ratio of the monofilament was measured before and after the heat treatment step (after heat setting and before heat setting), according to: Hot water dimensional change rate, Method B (filament shrinkage factor) of JIS-L-1013, and recorded as the boiling water shrinkage ratio. The initial measuring length was 500 mm, and the average value was calculated for 10 measurements of the dimensional change rate measured to two decimal places. When none of the samples could be ensured to have a measuring length of 500 mm, measurement was conducted with a measuring length of 100 mm, or when a measuring length of 100 mm could not be ensured, measurement was conducted with as long a measuring length as possible, without applying an initial load. Since this increased measurement error, however, the average value was calculated for 20 measurements.

### (6) Durability (Bristle-Breaking Resistance)

The durability (bristle breakage) was evaluated based on the degree of damage including bristle breakage when the obtained monofilament was formed into a toothbrush bristle material. A toothbrush with the brush bristle material lengths cut even to horizontal lengths of 7.00±0.15 mm was fabricated by a known method. The toothbrush was actually used by 10 monitors for 1 month, and the average degree of damage for the 10 toothbrushes was judged on the following evaluation scale.

G: No damage such as bristle breakage

F: Slight damage such as bristle breakage

P: Considerable damage such as bristle breakage

### (7) Softness (Usage Feel)

The softness (usage feel) for the obtained monofilament used as a toothbrush bristle material was evaluated by an organoleptic evaluation. A toothbrush with the brush bristle material lengths cut even to horizontal lengths of 7.00±0.15 mm was fabricated by a known method. The toothbrush was actually used by 10 monitors for 1 month, and was judged on the following evaluation scale.

G: Soft

F: Ordinary

P: Hard

### (8) Recoverability (Bristle-Opening Resistance)

The recoverability (bristle opening) was evaluated based on the degree of bristle opening when the obtained monofilament was formed into a toothbrush bristle material. A toothbrush with the brush bristle material lengths cut even to horizontal lengths of 7.00±0.15 mm was fabricated by a known method. The toothbrush was actually used by 10 monitors for 1 month, and the average degree of bristle opening for the 10 toothbrushes was judged on the following evaluation scale.

G: No bristle opening

F: Slight bristle opening

P: Considerable bristle opening

### (9) Overall Evaluation

For the overall evaluation, the aforementioned results for durability (bristle breakage), softness (usage feel) and recoverability (bristle opening) were judged together on the following evaluation scale.

VG: Evaluation of “G” for durability (bristle breakage), softness (usage feel) and recoverability (bristle opening)

G: Evaluation of “F” for durability (bristle breakage), softness (usage feel) or recoverability (bristle opening), and “G” for others

F: Evaluation of “F” for any two among durability (bristle breakage), softness (usage feel) and recoverability (bristle opening), and no “P” evaluation

P: Evaluation of “P” for durability (bristle breakage), softness (usage feel) or recoverability (bristle opening).

### Example 1

After premixing 80 wt % of titanium oxide-free PTT (DuPont) with limiting viscosity [η]=0.92 dl/g, and 20 wt % of titanium oxide-free PBT (Wintech Polymer, Ltd.) with limiting viscosity [η]=0.84 dl/g, and drying the mixture at 110° C., a monofilament was wound up under the following production conditions.

Polymer throughput: 2.52 (g/min)

Screw shear rate: 9.2 (/sec)

Residence time: 8 (min)

Spinning temperature: 260 (° C.)

Cooling bath water temperature: 40 (° C.)

Wind-up roll (first roll) peripheral speed: 15.8 (m/min)

Stretching bath water temperature: 55 (° C.)

Stretching roll (second roll) peripheral speed: 80 (m/min)

Heat treatment bath temperature: 160 (° C.)

Heat treatment medium: hot air

Third roll peripheral speed: 72 (m/min)

Wind-up speed: 72 (m/min)

A commercially available skein winding machine was used to form the wound monofilament obtained under these conditions into a skein having a circumference of 360 cm and a total weight of 30 kg, and it was then subjected to relaxation heat treatment for 48 hours, with the skein in a non-constrained state and set in a hot air drier set to 80° C., while maintaining a relaxed state until heat treatment was complete, to obtain a monofilament.

A toothbrush was then fabricated by a common method using the obtained monofilament. The physical properties of the monofilament are shown in Table 1. All of the properties of durability (bristle breakage), softness (usage feel) and recoverability (bristle opening) were evaluated as “G”, resulting in an overall evaluation of “VG”.

### Example 2

A monofilament was obtained by winding a monofilament and heat setting it under the same production conditions as Example 1, except that the mixing ratio of PTT and PBT in Example 1 was changed.

A toothbrush was then fabricated by a common method using the obtained monofilament.

The physical properties of the monofilament are shown in Table 1. All of the properties of durability (bristle breakage), softness (usage feel) and recoverability (bristle opening) were evaluated as “G”, resulting in an overall evaluation of “VG”.

### Example 3

A monofilament was obtained by winding a monofilament and heat setting it under the same production conditions as Example 1, except that the mixing ratio of PTT and PBT in Example 1 was changed.

A toothbrush was then fabricated by a common method using the obtained monofilament.

The physical properties of the monofilament are shown in Table 1. All of the properties of durability (bristle breakage), softness (usage feel) and recoverability (bristle opening) were evaluated as “G”, resulting in an overall evaluation of “VG”.

### Example 4

A monofilament was obtained by winding a monofilament and heat setting it under the same production conditions as Example 1, except that the heat setting time in Example 1 was changed.

A toothbrush was then fabricated by a common method using the obtained monofilament.

The physical properties of the monofilament are shown in Table 1. The property of durability (bristle breakage) was evaluated as “F”, but both softness (usage feel) and recoverability (bristle opening) were evaluated as “G”, resulting in an overall evaluation of “G”.

### Example 5

A monofilament was obtained by winding a monofilament and heat setting it under the same production conditions as Example 1, except that the heat setting temperature and time in Example 1 were changed.

A toothbrush was then fabricated by a common method using the obtained monofilament.

The physical properties of the monofilament are shown in Table 1. All of the properties of durability (bristle breakage), softness (usage feel) and recoverability (bristle opening) were evaluated as “G”, resulting in an overall evaluation of “VG”.

### Example 6

A monofilament was obtained by winding a monofilament and heat setting it under the same production conditions as Example 1, except that the heat setting temperature in Example 1 was changed.

A toothbrush was then fabricated by a common method using the obtained monofilament.

The physical properties of the monofilament are shown in Table 1. The property of softness (usage feel) was evaluated as “F”, but both durability (bristle breakage) and recoverability (bristle opening) were evaluated as “G”, resulting in an overall evaluation of “G”.

### Comparative Example 1

A monofilament was obtained by winding a monofilament and heat setting it under the same production conditions as Example 1, except that the mixing ratio of PTT and PBT in Example 1 was changed.

A toothbrush was then fabricated by a common method using the obtained monofilament.

The physical properties of the monofilament are shown in Table 1. The property of durability (bristle breakage) was evaluated as “P”, softness (usage feel) was evaluated as “F” and only recoverability (bristle opening) was evaluated as “G”, resulting in an overall evaluation of “P”.

### Comparative Example 2

A monofilament was obtained by winding a monofilament and heat setting it under the same production conditions as Example 1, except that the mixing ratio of PTT and PBT in Example 1 was changed.

A toothbrush was then fabricated by a common method using the obtained monofilament.

The physical properties of the monofilament are shown in Table 1. The property of durability (bristle breakage) was evaluated as “P”, softness (usage feel) was evaluated as “F” and recoverability (bristle opening) was evaluated as “P”, resulting in an overall evaluation of “P”.

### Comparative Example 3

A monofilament was obtained by winding a monofilament and heat setting it under the same production conditions as Example 1, except that the heat setting time in Example 1 was changed.

A toothbrush was then fabricated by a common method using the obtained monofilament.

The physical properties of the monofilament are shown in Table 1. The property of durability (bristle breakage) was evaluated as “F”, softness (usage feel) was evaluated as “F” and recoverability (bristle opening) was evaluated as “P”, resulting in an overall evaluation of “P”.

### Comparative Example 4

The wound monofilament was placed in a hot air drier as a wound body, and heat treated. The treatment was carried out in a non-constrained state, without external constraint of the yarn in the wound body, but tension was produced in the yarn as yarn shrinkage occurred during the heat treatment. A monofilament was obtained by winding a monofilament and heat setting it under the same production conditions as Example 1, except that the relaxation heat treatment was changed in this manner.

A toothbrush was then fabricated by a common method using the obtained monofilament.

The physical properties of the monofilament are shown in Table 1. The property of durability (bristle breakage) was evaluated as “F”, softness (usage feel) was evaluated as “F” and recoverability (bristle opening) was evaluated as “P”, resulting in an overall evaluation of “P”.

TABLE 1

| | | | Example | | | | | | Comparative Example | | | |
|---|---|---|---|---|---|---|---|---|---|---|---|---|
| Production/Properties/Evaluation | | | 1 | 2 | 3 | 4 | 5 | 6 | 1 | 2 | 3 | 4 |
| Production | Polymer ratio [%] | PTT | 80 | 70 | 65 | 80 | 80 | 80 | 100 | 55 | 80 | 80 |
| conditions | | PBT | 20 | 30 | 35 | 20 | 20 | 20 | 0 | 45 | 20 | 20 |
| | Heat setting | Temperature [° C.] | 80 | 80 | 80 | 80 | 90 | 100 | 80 | 80 | 80 | 80 |
| | | Time [hr] | 48 | 48 | 48 | 72 | 48 | 48 | 48 | 48 | 24 | 48 |
| Physical | Fiber diameter [μm] | | 171 | 180 | 176 | 171 | 171 | 179 | 178 | 175 | 170 | 171 |
| properties | Size [dtex] | | 310 | 348 | 334 | 311 | 312 | 349 | 350 | 332 | 307 | 310 |
| | Tensile strength [N] | | 8.65 | 8.87 | 8.31 | 7.29 | 8.21 | 5.85 | 9.02 | 9.12 | 8.36 | 8.65 |
| | Breaking strength [cN/dtex] | | 2.79 | 2.55 | 2.49 | 2.34 | 2.63 | 1.68 | 2.58 | 2.75 | 2.72 | 2.79 |
| | Ductility [%] | | 68.7 | 66.5 | 65.9 | 57.0 | 62.2 | 77.7 | 48.8 | 69.5 | 69.9 | 68.7 |
| | Toughness | | 23.13 | 20.79 | 20.20 | 17.70 | 20.75 | 14.81 | 18.00 | 22.92 | 22.77 | 23.13 |
| | Boiling water | After heat setting | 0.75 | 0.80 | 0.88 | 0.57 | 0.58 | 0.24 | 0.35 | 1.23 | 1.55 | 1.34 |
| | shrinkage ratio [%] | Before heat setting | 11.90 | 13.95 | 15.22 | 11.90 | 11.90 | 11.90 | 11.63 | 16.45 | 11.90 | 11.90 |

| | | | | | | | | | | | |
|---|---|---|---|---|---|---|---|---|---|---|---|
| Evaluated | Durability (bristle-breaking resistance) | G | G | G | F | G | G | P | P | F | F |
| properties | Softness (usage feel) | G | G | G | G | G | F | F | F | F | F |
| | Recoverability (bristle-opening resistance) | G | G | G | G | G | G | G | P | P | P |
| | Overall evaluation | VG | VG | VG | G | VG | G | P | P | P | P |

### INDUSTRIAL APPLICABILITY

The polyester-based monofilament for a toothbrush of the invention has excellent flexibility (usage feel), durability (bristle-breaking resistance) and recoverability (bristle-opening resistance), compared to a conventional polyester-based monofilament for a toothbrush, and it can therefore be suitably used for erected bristles in a toothbrush.

### REFERENCE SIGNS LIST

1 Dryer
2 Extruder
3 Bend
4 Spin head
5 Gear pump
6 Spinneret
7 Filamentous polymer
8 Cooling bath
9 First roll group
10 Stretching bath
11 Second roll group
12 Heat treatment bath
13 Third roll group
14 Winder

1. A polyester-based monofilament for a toothbrush comprising polytrimethylene terephthalate (PTT) and polybutylene terephthalate (PBT) blended in a weight ratio of 85/15 to 65/35, and having a boiling water shrinkage ratio of less than 1.0%.

2. The polyester-based monofilament for a toothbrush according to claim 1, wherein the toughness (=breaking strength (cN/dtex)×√breaking elongation (%)) of the monofilament is 18 or greater, and the breaking elongation is 55% or greater.

3. The polyester-based monofilament for a toothbrush according to claim 1, wherein the fiber diameter of the monofilament is 150 μm to 200 μm.

4. A toothbrush that employs a polyester-based monofilament for a toothbrush according to claim 1 as the erected bristles.

5. A method for producing a polyester-based monofilament for a toothbrush according to claim 1, wherein the method comprises the following steps:
a step of blending polytrimethylene terephthalate (PTT) and polybutylene terephthalate (PBT) in a weight ratio of 85/15 to 65/35, and then melt spinning the blend;
a step of stretching the melt spun monofilament, and then heat treating it and temporarily winding it; and
a step of heat treating the wound monofilament at a heat treatment temperature of 70° C. to 110° C. for a heat treatment time of 36 hours or longer in a non-constrained state, while maintaining a relaxed state until heat treatment is complete.

6. The polyester-based monofilament for a toothbrush according to claim 2, wherein the fiber diameter of the monofilament is 150 μm to 200 μm.

7. A toothbrush that employs a polyester-based monofilament for a toothbrush according to claim 2 as the erected bristles.

8. A toothbrush that employs a polyester-based monofilament for a toothbrush according to claim 3 as the erected bristles.

9. A method for producing a polyester-based monofilament for a toothbrush according to claim 2, wherein the method comprises the following steps:
a step of blending polytrimethylene terephthalate (PTT) and polybutylene terephthalate (PBT) in a weight ratio of 85/15 to 65/35, and then melt spinning the blend;
a step of stretching the melt spun monofilament, and then heat treating it and temporarily winding it; and
a step of heat treating the wound monofilament at a heat treatment temperature of 70° C. to 110° C. for a heat treatment time of 36 hours or longer in a non-constrained state, while maintaining a relaxed state until heat treatment is complete.

10. A method for producing a polyester-based monofilament for a toothbrush according to claim 3, wherein the method comprises the following steps:
a step of blending polytrimethylene terephthalate (PTT) and polybutylene terephthalate (PBT) in a weight ratio of 85/15 to 65/35, and then melt spinning the blend;
a step of stretching the melt spun monofilament, and then heat treating it and temporarily winding it; and
a step of heat treating the wound monofilament at a heat treatment temperature of 70° C. to 110° C. for a heat treatment time of 36 hours or longer in a non-constrained state, while maintaining a relaxed state until heat treatment is complete.
